(19) United States
(12) Patent Application Publication
(10) Pub. No.: US 2022/0037960 A1
(43) Pub. Date: Feb. 3, 2022

(54) Electrical generator for luggage

(71) Applicants: Gennes Daniel Curescu, Skokie, IL (US); Marius Strizu, Gresham, OR (US)

(72) Inventors: Gennes Daniel Curescu, Skokie, IL (US); Marius Strizu, Gresham, OR (US)

(21) Appl. No.: 16/943,705

(22) Filed: Jul. 30, 2020

(51) Int. Cl. H02K 7/18; A45C 5/14; H02K 1/12; H02K 1/22

(52) U.S. Cl. CPC H02K 7/1846; H02K 1/22; H02K 1/12; A45C 5/14

(57) ABSTRACT

The present invention is directed to an electrical generator assembly for wheeled luggage. The assembly construction is robust and includes an anti-skid sleeve. Wiring for the generator is positioned within the assembly so as to reduce the possibility of accidental disconnection. A protective baffle is used to prevent the accumulation of debris that can hinder the smooth rolling of the wheel thereby allowing for more consistent power generation.

### FIELD OF THE INVENTION

The present invention relates to power generation. More particularly, the invention discloses a device that generates electricity from rolling luggage.

### BACKGROUND OF THE INVENTION

Power generating devices using rotating magnet assemblies are well known in the art. Both generators and alternators run on the basic principle of producing electricity from an AC magnetic field.

Recently, luggage manufacturers have begun installing rechargeable batteries in luggage, the batteries electrically connected to one or more terminals for powering and charging various electronic devices. The luggage includes an AC adapter to allow the luggage battery to be charged. Some luggage manufacturers have even taken to using rotating magnet assemblies to provide a charge for the luggage battery and/or devices.

The drawback with prior art assemblies is that the wheel assemblies used with the luggage are of inferior quality. Poor quality wheel assemblies result in a number of problems. First, the wheels tend to skid, bounce, turn sideways, or otherwise roll inconsistently which leads to a very low amount of electricity generated. This problem is exacerbated when rolling the luggage on uneven surfaces. Also, poor quality construction leads inevitably to one or more electrical components becoming disconnected as the luggage is exposed harsh rolling conditions that produce a lot of shock to internal wheel assembly components. Finally, dirt and debris can enter the wheel assembly and jam the wheels, resulting in the wheel rolling inconsistently or even not at all.

The present invention is directed to an electrical generator assembly for wheeled luggage. The assembly construction is robust and includes an anti-skid sleeve. Wiring for the generator is positioned within the assembly so as to reduce the possibility of accidental disconnection. A protective baffle is used to prevent the accumulation of debris that can hinder the smooth rolling of the wheel thereby allowing for more consistent power generation.

### SUMMARY OF THE INVENTION

It is a major object of the invention to provide an improved electrical power generator for wheeled luggage.

It is another object of the invention to provide an improved electrical power generator for wheeled luggage which is robust in construction.

It is another object of the invention to provide an improved electrical power generator for wheeled luggage having a plurality of rotating magnet operatively connected to the luggage wheels to generate an AC magnetic field.

It is another object of the invention to provide an improved electrical power generator for wheeled luggage having an anti-skid sleeve.

It is another object of the invention to provide an improved electrical power generator for wheeled luggage having means to prevent the accumulation of the debris within the case wheel assembly.

### BRIEF DESCRIPTION OF THE DRAWINGS

FIG. 1 shows a front view of a suitcase modified in accordance with the invention.

FIG. 2 shows a perspective view of the underside of the suitcase of FIG. 1.

FIG. 3 shows a perspective view of the wheel assembly of the invention.

FIG. 4 shows an exploded right side perspective view of the wheel assembly of the invention.

FIG. 5 shows an exploded left side perspective view of the wheel assembly of the invention.

FIG. 6 shows a side cross section of the wheel assembly of the invention.

### DETAILED DESCRIPTION

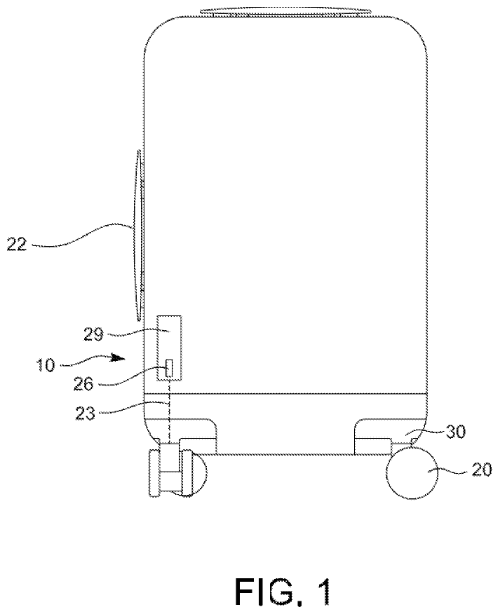

The present invention is directed to a power generating assembly for wheeled luggage. As can be seen from FIG. 1, the wheeled luggage 10 may be conventional travel luggage comprising a generally rectangular body 12 for storing luggage therein, and supported by four luggage wheels 20 at a lower surface 21 thereof and comprising a luggage handle 22 at an upper surface thereof. As such, the wheeled luggage 10 may be maneuvered about by the luggage handle 22 while being supported by the luggage wheels 20.

In this regard, it should be noted that the power generating assembly provided herein may be configured for retrofitting existing conventional wheeled luggage or, in alternative embodiments, integrally provided during the manufacture thereof.

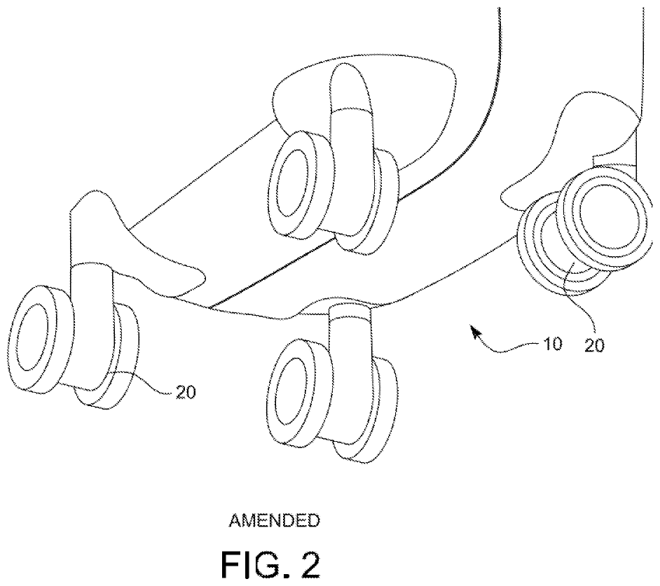

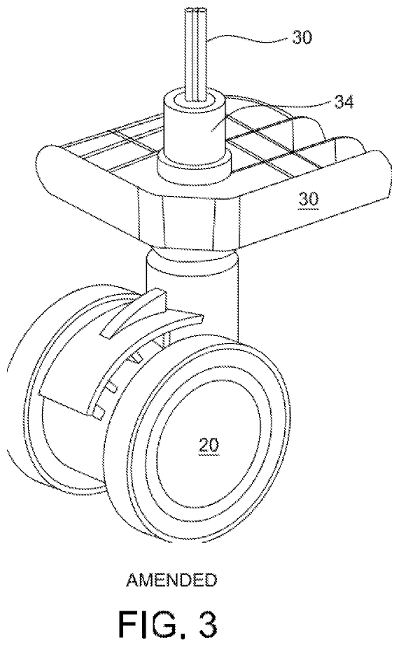

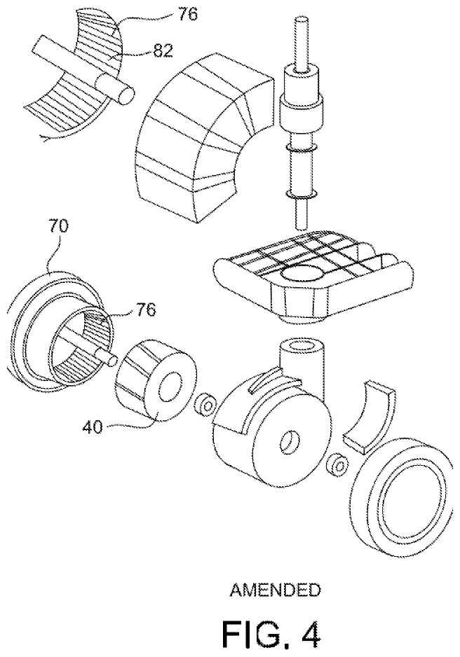

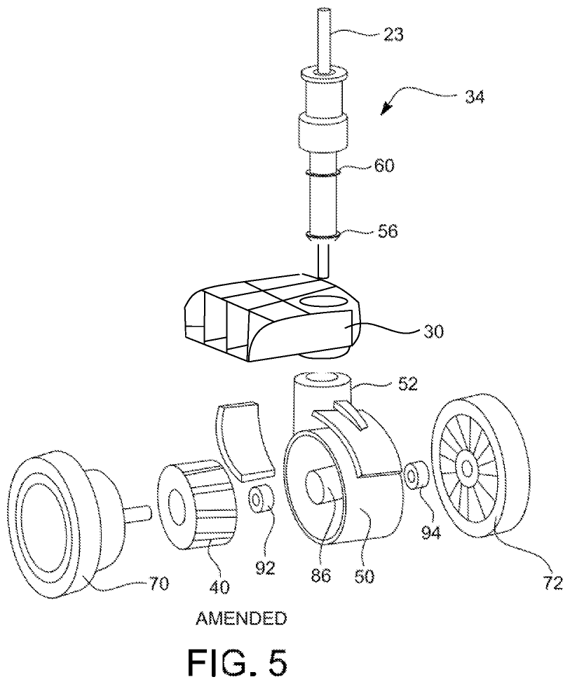

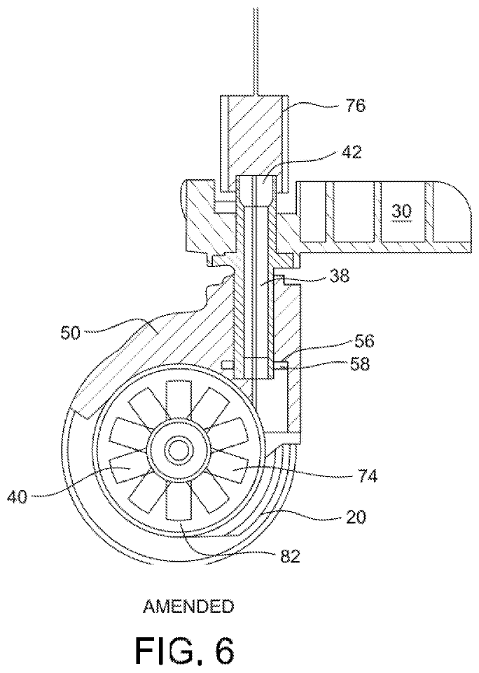

As can be seen more particularly in FIGS. 2-6, each wheel 20 has a power generation circuit and associated assembly. The wheels are of the spinner wheel type, and are modified in accordance with the inventive concept. Power generated from the rolling wheels 20 is supplied via a conductor (a wire) 23 to a single microprocessor controlled power regulator 24 which is disposed interiorly of the luggage. Power regulator 24 includes a terminal 26 which may be configured to receive a male plug connected to a device to be charged. Power received by the regulator 24 is converted to DC at a voltage of about 5 volts as would be apparent to one of skill in the art. Regulator 24 only outputs power when the wheels 20 are rolling, and a predetermined minimum amount of power is generated by the rolling wheels.

The wheel assembly housing 30 is attached to the lowermost surface 21 of the luggage 10 and has an aperture 32 through which an upstanding strut 34 is inserted. The strut 34 has different diameter portions 36, 38, with relatively large diameter portion 36 having external threads 40 for threaded engagement within aperture 32 which is internally threaded. The top end 42 of the small diameter portion 38 is positioned for free rotation within portion 36 and in axial alignment therein. An annular bearing may be positioned within portion 36 to aid in rotation as would be apparent to one of skill in the art. Thus, the strut 34 allows for free rotation or pivoting of the wheel 20. Strut 34 has a central bore through which conductor 23 is inserted.

Wheel support 50 includes an upstanding portion 52 having a generally cylindrical shape with a central vertically oriented bore 54 formed therein sized for rotatably receiving the small diameter portion 38 of strut 34. Lower annular flange 56 is seated within an annular recess 58 formed in wheel support 50, and acts in combination with upper flange 60 seated within recess 62 of wheel housing 30 to maintain the vertical spacing between the housing 30 and the support 50.

The wheel 20 includes left 70 and right 72 wheel portions, the portions having a larger diameter than wheel support 50 so that only wheel portions 70, 72 are in contact with the ground. A rotating magnet and coil assembly 41 are positioned within the wheel 20 so as to generate electrical power. Power generated from the rotating magnets 76 and stationary coil 74 is conducted via conductor 23 to terminal 26 to charge devices as stated above. Optionally, conductor 23 is connected to regulator 24 which charges a battery, with terminal 26 connected to the battery.

Rotating magnet assembly includes a plurality of magnets 76 arranged on the circumferential inner surface 80 of the left wheel portion 70, the assembly sized for insertion and contact free rotation within an enclosure or cavity 82 formed in wheel support 50. The magnets 76 thus rotate with the left wheel portion 70, the rotation causing the generation of an AC magnetic field. A rotating pin 84 or axle is connected to left wheel portion for rotation therewith. Coil assembly column 86 extends centrally from right wheel portion 72 with coil assembly 41 positioned thereon in non rotating fashion. The rotating magnet assembly generates a robust current because of the shape, position, and size of the magnets 76 and coil assembly. Specifically, rotating magnets 76 are bar magnets that extend transversely across the inner surface 80 of the left wheel portion 70 of each wheel. With minimum spacing between adjacent magnets, a strong magnetic field is generated. Also, having the magnets arranged about or proximate the outer diameter of the wheel 20, the inertia of the rotating portion of the wheel 20 is increased, meaning the wheel is more likely to continue rolling when not in contact with the ground. Coil assembly 41, which is massive or heavy compared to the plastic of the rest of the wheel assembly gives extra weight to the wheel so as to keep it grounded. Having the coil assembly 41 fill most of the space within cavity ensures maximum current generation while also providing additional mass to reduce the incidence of wheels skidding and bouncing. Accordingly, coil assembly 41 should utilize at least 90 percent of the space within cavity 82 so as to effectively increase the mass of the wheel 20. Rotating pin 84 extends through column 86 and into a socket 90 formed in right wheel 72 where it is secured in non rotating fashion so as to cause right wheel 72 to rotate with left wheel 70. Column 86 is non-rotational so that rotating pin 84 rotates within column 86. A pair of axially aligned bearings 92, 94 disposed on opposite sides of support 50 receive pin 84 which is inserted therethrough, the bearings 92, 94 serving to provide smooth rotation of the wheel 20 as is known in the art. An anti-skid sleeve 96 is provided on left wheel 70 to reduce skidding, the reduced skidding allowing for more consistent power generation as the wheel does not rotate when skidding and therefore generates no power when skidding.

In operation, rotation of the wheel 20 causes rotation of the magnets 76 creating an AC magnetic field. Coil assembly 41 receives the field and generates current which can be used to power devices. The anti skid sleeve, in combination with the extra bearings cooperate to reduce skidding and other wheel rotation issues that result in loss of power.

I claim:

1. An electrical generator assembly for wheeled luggage, said luggage having wheel assemblies, the generator assembly comprising:
magnets positioned for rotation with wheels positioned in said wheel assemblies;
a coil assembly positioned in non-rotating manner within each of said wheel assemblies, the coil assembly positioned to receive a magnetic field from said magnets; and,
an anti-skid sleeve positioned within each of said wheel assemblies to reduce skidding of said wheels.

2. The assembly of claim 1 wherein each of said wheels has a left and right portion, said portions forming an enclosure and said left portion having a circumferential inner wall;
said magnets positioned on said inner wall;
wherein rolling inertia of each of said wheels is enhanced by said magnets.

3. The assembly of claim 2 wherein said coil assembly is positioned within said enclosure.

4. The assembly of claim 2 wherein said coil assembly is stationary within said enclosure when said wheel is rotating.

5. The assembly of claim 3 wherein said coil assembly uses at least 90 percent of available space within said enclosure.
